(19) United States
(12) Patent Application Publication
(10) Pub. No.: US 2003/0225648 A1
(43) Pub. Date: Dec. 4, 2003

(54) Constant leverage synthetic assets

(76) Inventor: Ronald Hylton, New York, NY (US)

Correspondence Address: MINTZ LEVIN COHN FERRIS GLOVSKY & POPEO, 666 THIRD AVENUE, NEW YORK, NY, 10017, US

(21) Appl. No.: 10/421,261

(22) Filed: Apr. 23, 2003

Related U.S. Application Data
(60) Provisional application No. 60/383,722, filed on May 28, 2002.

(51) Int. Cl. G06F 17/60

(52) U.S. Cl. 705/35

(57) ABSTRACT

A method of applying a substantially constant leverage to a value of a log-normal distributed asset includes providing an underlying log-normal distributed asset having an original volatility σ and an original yield q. The asset includes an associated value S denominated in a currency having an associated interest rate r. The method and system also include applying a leveraging factor L to produce a modified value, volatility and/or a modified yield.

### RELATED APPLICATIONS

This application claims benefit under 35 U.S.C. § 119(e) of U.S. Provisional Patent Application No. 60/383,722, filed May 28, 2002, the entire disclosure of which is herein incorporated by reference.

### BACKGROUND OF THE INVENTION

1. Field of the Invention

The present invention relates to the creation of synthetic assets, based on leveraging log-normally distributed assets (e.g., stocks, equity indices, foreign exchange rates, precious metals, commodities, bond prices under certain circumstances, and baskets of the preceding) or based on leveraging other assets, and more particularly, in certain embodiments of the invention, creating synthetic assets based on leveraging locally log-normally distributed assets (for example) and thus modifying the base asset's volatility and return.

2. Background

The financial industry has provided a multitude of methods and mechanisms for financial gain. Investors may use options such as calls and puts, shorting of securities and purchasing securities on margin to create returns in different market conditions.

Currently, for example, investors using margin accounts are able to leverage their accounts to purchase up to twice the amount of securities that they would normally be able to purchase using available cash alone. However, an investor must pay interest on the amount of money invested that is on margin. In effect, margin allows an investor to purchase securities with borrowed money, using the purchase shares as collateral. Investors may also use a margin account to borrow a security rather than money and sell it short, usually depositing cash as collateral, and again incurring costs related to the financing of the position.

In a margin account, if the price of the purchased security moves in a beneficial manner for the investor (either up or down depending upon the investor's position), the investor merely pays financing costs in anticipation that he will close the position at a future time to realize the return from the beneficial price movement. However, under SEC regulations, (Regulation T), when the price of the margined security is subject to a price movement adverse to the investor's position, and the value of the account is less than a predetermined percentage of the value of the margined securities established by the Security and Exchange Commission (Regulation T), the investor receives a call from his broker (a maintenance margin call) demanding the deposit of cash or marginable securities to satisfy the Regulation T requirements to cover the adverse price movement. Accordingly, this illustrates the major resultant drawback of margin accounts: upon the occurrence of adverse price movements the investor may lose more than his original cash investment.

By investing in options rather than through a margin account the investor can obtain leverage while avoiding the risk of losing more than the original investment, but option purchases still entail a significant probability of losing the entire investment if held to maturity.

Further, the leverage achieved by an investor through the use of a margin account or options is not constant but rather changes continually as the value of the underlying asset changes. For example a margined purchase with an initial leverage of two will have a leverage less than two if the position moves in the investor's favor and will have a leverage greater than two if the position moves adversely to the investor. To maintain constant leverage an investor would need to continually buy and sell securities, which is not feasible for the vast majority of investors. Options similarly have a leverage that decreases as the investment performs favorably but increases as the investment performs adversely.

If instead the investor's leverage were held constant it would be very unlikely that he would lose the entire investment and impossible for him to lose more than the original investment, as demonstrated below. Accordingly there exists a need for a financial product that keeps the investor's leverage constant without the need for continual action by the investor.

### SUMMARY OF THE INVENTION

Accordingly, the present invention overcomes the above-noted problem and presents a novel method and system to create a new asset that is a derivative of an original asset, yielding properties potentially more attractive to investors. If the original asset is log-normally distributed then the synthetic asset will also be log-normally distributed. In particular, the present invention allows for the leveraging of an asset's volatility and instantaneous return either up or down and even negatively by a constant factor while reflecting the change in volatility in the asset's yield.

The present invention also presents a system and method for taking two assets, (for example) a target asset plus a benchmark asset, to create a new asset which has a constant instantaneous return leverage against both the target and benchmark. If both original assets are log-normally distributed then the synthetic asset will also be log-normally distributed. The new “synthetic” asset is a derivative of the original assets whose volatility and beta against the benchmark are separately adjustable, with the value of the adjustments again reflected in the yield. The price performance of the synthetic asset may be regarded as tied to the outperformance or underperformance of the target relative to the benchmark with adjustable leverages.

A particularly interesting embodiment of the invention is presented where the benchmark is “the market” and the synthetic asset is adjusted to be market-neutral (i.e. it becomes a pure play on the non-systematic component or alpha of the target asset). The method according to this embodiment may be easily extended for use in any number of existing assets to create a new asset whose volatility and correlations to the original assets can be adjusted while the changes are reflected in the yield. The synthetic assets according to the present invention are derivatives that can be sold outright or used as the underlier in other derivatives, e.g. calls, puts, forwards and structured notes. In that regard, since synthetic assets based on log-normal underliers are themselves log-normally distributed, all the usual formulas and models can be applied.

In yet another embodiment of the present invention, the synthetic assets can also be used to create a new kind of investment (e.g., brokerage) account.

Leverage is a key indicator of the riskiness of an investment: a leverage of two (2) is twice as risky as a leverage of one (1) (in the same asset). If the underlying asset changes by 1%, then an investment with a leverage of 2 changes by essentially 2%.

With an ordinary investment, simply buying the asset gives a leverage of one (1). By buying or selling short on margin or using options, investors may achieve other values of leverage. However, the leverage achieved using margin or options is not constant—the leverage changes continually as the value of the underlying asset changes, and for options, it also changes as the remaining time to maturity changes or the implied volatility of the option or the relevant interest rate or estimated dividends change.

For example, an investor uses $100 cash and buys $200 worth of stock in a margin account, giving a leverage of two (2). If the stock value goes to $300, his leverage becomes 1.5 ($300 stock value divided by $200 investment value). Alternatively, if the stock value falls to $150, his leverage becomes three (3) ($150 stock value divided by $50 investment value, ignoring the possibility of a margin call). Thus, the investor's leverage and risk decrease as the investment moves in his favor, but increase as the investment moves against the investor unless he takes action to adjust his risk. Selling short on margin and investing in options generally has the same undesirable pattern of decreasing leverage to the upside and increasing it to the downside. Thus, to avoid this problem, the investor would have to be constantly monitoring his investments and re-adjusting his leverage and risk. In contrast, the current invention keeps the investor's leverage and risk substantially constant without investor intervention.

Accordingly, in one embodiment of the present invention, a synthetic asset includes a first underlying asset having a value S. An instantaneous value Z of the synthetic asset is substantially in accordance with the formula Z=S^{L}, where L is neither 0 nor 1 and L is substantially constant over a period of time.

In another embodiment of the present invention, a synthetic asset includes an underlying asset having a value S and a plurality of financial derivatives thereof. An instantaneous value Z of the synthetic asset is substantially in accordance with the formula Z=S^{L}, where L is neither 0 nor 1 and L is substantially constant over a period of time.

In another embodiment of the present invention, a synthetic asset includes an underlying asset having a value S and a benchmark asset having a value of B. An instantaneous value Z of the synthetic asset is substantially in accordance with the formula Z=S^{L}/B^{K}. Neither L nor K is 0 and the absolute value of either L or K differs from 1 and wherein L and K are substantially constant over a period of time.

In another embodiment of the present invention, a synthetic asset includes at least one first underlying asset with value S and at least one financial derivative of the first underlying asset. An instantaneous value of the synthetic asset is substantially in accordance with the formula Z=S^{L}, where L is substantially constant and is neither 0 nor 1.

In yet another embodiment of the present invention, a method of leveraging the value of an asset includes providing an underlying asset having a value S, selecting a substantially constant leveraging factor L and associating an instantaneous value Z to the asset substantially in accordance with the formula Z=S^{L}, where L is neither 0 nor 1.

In another embodiment of the present invention, a method of creating a synthetic asset based upon applying a substantially constant leverage to the value of an asset includes providing an underlying asset having an associated value S and applying a substantially constant leveraging factor L to the underlying asset to create a synthetic asset. An instantaneous value Z of the synthetic asset is substantially in accordance with the formula Z=S^{L}, wherein L is different from 0 and 1.

In another embodiment of the present invention, a method of creating a synthetic asset based upon applying substantially constant leverages to the values of a pair of assets includes providing a first underlying asset having an associated value S, providing an underlying benchmark asset having an associated value B, applying a substantially constant leveraging factor L to the first asset and a substantially constant negative leveraging factor K to the benchmark asset to create a synthetic asset. An instantaneous value Z of the synthetic asset is substantially in accordance with the formula Z=S^{L}/B^{K}, where neither L nor K is 0 and the absolute value of either L or K differs from 1.

In another embodiment of the present invention, a method of investing includes providing an account having an amount of cash deposited therein by holder of the account, allocating a portion of the cash for investing into at least one synthetic asset based on an underlying asset, the underlying asset includes a value S, and purchasing at least one synthetic asset with at least a portion of the allocated cash. The synthetic asset includes an instantaneous value substantially in accordance with the formula Z=S^{L} and L comprises a leveraging factor which is neither 0 nor 1.

In another embodiment of the present invention, a synthetic asset includes a first underlying asset having a value S and being leveraged by a substantially constant value L. An instantaneous value of the synthetic asset is substantially in accordance with the formula Z=S^{L}, where L is neither 0 nor 1. The leverage is automatically increased in an upward moving market and automatically decreased in a downward moving market.

In yet another embodiment of the present invention, a method of creating a substantially log-normally distributed synthetic asset based upon applying substantially constant leverage to a value of a substantially log-normally distributed underlying asset includes providing an underlying substantially log-normally distributed asset having an original volatility a and an original yield q, where the asset includes an associated value S in a currency having an interest rate r, applying a substantially constant leveraging factor L, which is neither 0 nor 1, to the asset to produce: a modified volatility σ_{Z} for the synthetic asset substantially in accordance with the formula σ_{Z}=Lσ, and a modified yield q_{Z} for the synthetic asset substantially in accordance with the formula q_{Z}=L q+(1−L)r−½L (L−1) σ². An instantaneous value Z of the synthetic asset is substantially in accordance with the formula Z=S^{L}.

In another embodiment of the present invention, a method of creating a substantially log-normally distributed synthetic asset based upon applying substantially constant leverages to values of a pair of substantially log-normally distributed assets, the method including providing a first underlying substantially log-normally distributed asset having an original volatility σ_{S} and an original yield q_{S}, where the first asset includes an associated value S in a currency having an interest rate r, providing an underlying substantially log-normally distributed benchmark asset having an original volatility σ_{B} and an original yield q_{B}, where the benchmark asset includes an associated value B in the same currency, providing a correlation factor ρ between the first asset and the benchmark asset, applying a substantially constant leveraging factor L to the first asset and a substantially constant negative leveraging factor K to the benchmark asset to produce: a modified volatility σ_{Z} for the synthetic asset substantially in accordance with the formula

σ_{Z}={(L²*σ²_{S})+(K²*σ²_{B})−(2*L*K*ρ*σ_{S}*σ_{B})}^{1/2}, and

a modified yield q_{Z} for the synthetic asset substantially in accordance with the formula

q_{Z}=(L*q_{S})−(K*q_{B})+((1+K−L)*r)−(½* L*(L−1)*σ²_{S})−(½*K*(K+1)*σ²_{B})+(L*K*ρ*σ_{S}*σ_{B}).

An instantaneous value Z of the synthetic asset is substantially in accordance with the formula Z=S^{L}/B^{K}, where neither L nor K is 0 and the absolute value of either L or K differs from 1.

In another embodiment of the present invention, a system for leveraging the value of an asset includes a computer system in communication with a computer network, where the computer system presents an underlying asset having a value S, and input means for selecting a substantially constant leveraging factor L. An instantaneous value Z of the underlying asset is substantially in accordance with the formula Z=S^{L}.

In another embodiment of the present invention, a system for creating a synthetic asset based upon applying substantially constant leverages to the values of a pair of assets includes a computer system in communication with a computer network for presenting a first underlying asset, where the first asset includes an associated value S, and for presenting an underlying benchmark asset, where the benchmark asset includes an associated value B. The computer system also includes input means for selecting a substantially constant leveraging factor L for the first asset and a substantially constant negative leveraging value K for the benchmark asset, and an instantaneous value Z of the synthetic asset is substantially in accordance with the formula Z=S^{L}/B^{K}.

In another embodiment of the present invention, a system for investing in an asset includes a computer system in communication with a computer network, the computer system for presenting and/or interacting with an account having an amount of cash deposited therein by holder of the account and input means for allocating a portion of the cash for investment into at least one synthetic asset based on an underlying asset and/or for selecting a substantially constant leveraging factor L. The underlying asset includes a value S and the synthetic asset is purchased with at least a portion of the allocated cash. The synthetic asset includes an instantaneous value substantially in accordance with the formula Z=S^{L}.

In another embodiment of the present invention, a system for investing in an asset includes a computer system in communication with a computer network, the computer system for presenting and/or interacting with an account having an amount of cash deposited therein by holder of the account, and input means for allocating a portion of the cash for investment into at least one synthetic asset based on two underlying assets and/or for selecting substantially constant leveraging factors L and K for the synthetic asset. The underlying assets includes a value S and a value B, the synthetic asset is purchased with at least a portion of the allocated cash, and the synthetic asset includes an instantaneous value substantially in accordance with the formula Z=S^{L}/B^{K}.

In yet another embodiment of the present invention, a synthetic asset includes a financial derivative of an underlying asset having a value S, where the synthetic asset includes a value at time t substantially in accordance with the formula Z=(S/S_{BREAK-EVEN}(t))^{L}. L is a substantially constant leverage value different from 0 and 1.

In another embodiment of the present invention, a multi-period compound synthetic asset includes at least one financial derivative of an underlying asset having a value S and being leveraged by a substantially constant value L during each period. The return of the synthetic asset during each period is substantially in accordance with the difference between a second Z value of the synthetic asset at the end of the period and a first Z value at the beginning of the period divided by the first Z value. Z is substantially in accordance with the formula Z=S^{L}, where the total return of the synthetic asset is the compounded return of the distinct periods, and L is potentially neither 0 nor 1 in at least one period.

In another embodiment of the present invention, a multi-period synthetic asset includes a pair of underlying assets, where the return of the synthetic asset during each period is substantially in accordance with the difference between a second value Z of the synthetic asset at the end of the period and a first value Z at the beginning of the period divided by the first value Z. Z is substantially in accordance with the formula Z=S^{L}/B^{K}, where the total return of the synthetic asset is the compounded return of the distinct periods. L is substantially constant during each period and potentially different from 1 in at least one period, and K is substantially constant and potentially different from 0 in at least one period.

In another embodiment of the present invention, a method of managing an investment account includes allocating an amount of cash in an investment account for purchasing one or more positions in one or more underlying assets and/or derivatives thereof, purchasing at least one such position for the account with the allocated cash and targeting a value Z of each position of the account substantially in accordance with the formula Z=A*S^{L}. Each value of S is substantially equal to the value of the corresponding underlying asset, each L is a substantially constant leverage factor for the corresponding position, and each A is the number of units of the corresponding position.

In another embodiment of the present invention, a method of managing an investment account includes allocating an amount of cash in an investment account for purchasing one or more positions in one or more underlying target or benchmark assets and/or derivatives thereof, purchasing at least one such position for the account with the allocated cash and targeting a value Z of each position of the account substantially in accordance with the formula Z=A*S^{L}/B^{K}. S is substantially equal to the value of a corresponding target asset, L is a substantially constant leverage factor for the corresponding target asset, A is the number of units of the corresponding position, B is substantially equal to the value of a corresponding benchmark asset and K is a substantially constant negative leverage factor for the corresponding benchmark asset.

In yet another embodiment of the present invention, a system for managing an investment account includes a computer system in communication with a computer network for presenting and/or interacting with an investment account and input means for allocating an amount of cash of the investment account for purchasing one or more positions in one or more underlying assets and/or derivatives thereof and/or for selecting a leverage factor for the position and for purchasing at least one such position for the account with the allocated cash. A value Z of each position of the account is targeted substantially in accordance with the formula Z=A*S^{L}, where each value of S is substantially equal to the value of the corresponding underlying asset, L is a substantially constant leverage factor for the corresponding underlying asset and A is a number of units of the corresponding position.

In another embodiment of the present invention, a system for performing a method of managing an investment account includes a computer system in communication with a computer network for presenting and/or interacting with an investment account and input means for allocating an amount of cash for purchasing one or more positions in one or more underlying or benchmark assets and/or derivatives thereof and/or for selecting leverage factors for the position and for purchasing at least one such position for the account with the allocated cash. A value Z of each position of the account is targeted substantially in accordance with the formula Z=A*S^{L}/B^{K}, where S is substantially equal to the value of a corresponding underlying asset, L is a substantially constant leverage factor for the corresponding underlying asset, A is a number of units of the corresponding position, B is substantially equal to the value of a corresponding benchmark asset, and K is a substantially constant negative leverage value associated with the benchmark asset.

In another embodiment of the invention, a method of delta-hedging a synthetic asset is provided, wherein the delta value for hedging is substantially in accordance with the formula δ=L*(Z/S).

Other embodiments of the invention include other methods and systems as well as computer readable media having computer instructions provided thereon for enabling a computer system to perform one or more of the method embodiments of the invention, and computer application programs for performing one or more of the method embodiments on a computer system, for example.

The advantages of the constant leverage synthetic assets according to the present invention over other methods of adjusting leverage (e.g. buying and selling short on margin, buying calls and puts) include:

Synthetic assets are simpler and more transparent. There are no option pricing formulas, margin calculations or option exercises, expiries or choices of strike.

The leverage is constant and can be any value. The alternatives have leverages that change with time or underlier value and generally have the undesirable property of increasing leverage on the way down and decreasing it on the way up.

The investor generally cannot lose more than the original investment and (unlike options and investing on margin), it's substantially unlikely that the inventor would lose the total investment. No margin calls are possible.

For a leverage value L between 0 and 1 (0<L<1) (de-leveraging) the investor may monetize volatility and receive an attractive yield that may have tax advantages.

The decisions on how much to invest and what leverage is desired are completely independent.

Synthetic assets are more attractive and suitable for retail investors.

Synthetic assets based on log-normal underliers have the familiar log-normal characteristics and can easily be used as the underlier in other derivatives.

Synthetic assets can provide retail investors with access to investment types that are currently unavailable, such as outperformance, underperformance, and the monetization of volatility and covariance.

Switchable beta adjustments (explained below) might offer a form of inexpensive downside protection under the view that the broad market is pulling down a sound stock.

These and other advantages and features of the invention will be apparent through the detailed description of the embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates the relationship between Z and S for different values of L according to an embodiment of the present invention.

FIG. 2 illustrates the values of Z versus S for different values of K according to an embodiment of the present invention.

FIG. 3 illustrates three years of history for synthetic assets based on Cisco Systems Inc. (CSCO) with various leverages according to an embodiment of the present invention.

FIGS. 4A-4D illustrate the leverage for standard puts and calls on a stock as a function of time to expiry and spot according to an embodiment of the present invention.

FIG. 5 illustrates market-neutral examples for σ_{S}=50%, q_{S}=0, σ_{B}=20%, q_{B}=1.5%, r=5% according to an embodiment of the present invention.

FIG. 6 illustrates the profit/loss for a portfolio that contains a $100 short position in Z, plus delta hedges under the following scenario: L=K=1, S=B=100, and then the market gaps, according to an embodiment of the present invention.

FIG. 7 illustrates a graph of three possible leverages (1, 0.5 and 0.1), separated by “barriers” in the asset value, according to an embodiment of the present invention.

FIG. 8 illustrates a client/server computer system embodiment for operating method embodiments according to the present invention.

### DETAILED DESCRIPTION OF THE PREFERRED EMBODIMENTS

The following general definitions are provided as reference for the detailed description of the preferred embodiments of the present invention that follow.

Definitions:

Call: an option contract that gives the holder the right to buy a certain quantity of an underlying security from the writer of the option, at a specified price up to a specified date.

Cover: to repurchase a previously sold contract.

Covered Call: the selling of a call option while simultaneously holding an equivalent position in the underlying security.

Covered Option: an option contract backed by the shares underlying the option.

Covered Put: the selling of a put option while being short an equivalent amount in the underlying security.

Delta: the change in price of a derivative for every one point move in the price of the underlying security.

Delta Hedging: an options strategy designed reduce the risk associated with price movements in the underlying asset, achieved through offsetting long and short positions.

Derivative: a financial instrument whose characteristics and value depend upon the characteristics and value of an underlying instrument or asset.

Futures: a standardized, transferable, exchange traded contract that requires delivery of an asset at a specified price, on a specified future date.

Gamma: a measurement of how fast delta changes, given a unit change in the underlying security price.

Index: a statistical indicator providing a representation of the value of the securities which constitute it. Indices often serve as barometers for a given market or industry and benchmarks against which financial or economic performance is measured.

Log-normal distribution: a probability distribution in which the log of the random variable is normally distributed (conforming to a bell curve).

Option: the right, but not the obligation to purchase or sell a specific amount of a given asset, at a specified price during a specified period of time.

Put: an option contract that gives the holder the right to sell a certain quantity of an underlying security to the writer of the option at a specified price up to a specified date.

Security: An investment instrument other than an insurance policy or fixed annuity issued by a corporation, government or other organization which offers evidence of debt or equity.

Underlier: a security or commodity which is subject to delivery upon exercise of an option contract or convertible security, not including index options and futures (which cannot be delivered and are therefore settled in cash), also includes a basket of underliers.

Variance swap: a contract in which two parties agree to exchange cash flows based on the measured variance of a specified underlying asset during a certain time period.

Vega: the change in the price of an option than results from a 1% change in volatility.

Volatility: the relative rate at which the price of an asset moves up or down, calculated by annualized standard deviation of the daily change in price.

Writer: the seller of an option contract.

Yield: the annual rate of return on an investment expressed as a percentage.

Leveraging the Instantaneous Return and Volatility of an Asset

In one embodiment of the present invention, a system and method of applying a substantially constant leverage to a value of a log-normally distributed asset or other asset is provided. Accordingly, the constant leverage synthetic asset includes providing an underlying log-normally distributed asset having an original volatility σ and an original yield q. The asset includes an associated value S denominated in a currency having an associated interest rate r. The method and system according to this embodiment also include applying a leveraging factor L to produce a modified value, volatility and/or a modified yield.

Accordingly, let S be the value of a log-normal asset (e.g., an asset undergoing instantaneous geometric Brownian motion—see Appendix A) having a volatility σ and a yield q. Let r be a yield (% interest rate) for the currency that S is denominated in.

A synthetic asset Z is created whereby the instantaneous value of Z at a time t is

Z(t)=S(t)L.

A constant leverage payoff function for the present invention includes the formulas:

Z(t)=N*X(t)^{L} for a single underlier

Z(t)=N*X₁(t)^{L}₁*X₂(t)^{L}₂, for a double underlier: which may also sometimes be written

Z(t)=N*X₁(t)^{L}/X₂(t)^{K}, where L and K are positive numbers;

for any number of underliers:

$$Z ( t ) = N * {\prod }_{i = 1}^{n} {{X}_{i} ( t )}^{{L}_{i}}$$

Z(t) is the value at time t, N is a notional amount or scale factor, and the L's are positive or negative numbers. S(t), X(t) and Xᵢ(t) are the prices or values at time t of the underlier(s).

Z will normally be denominated in the same units as the underliers when all underliers have the same units; in the case of multiple underliers with mixed units there will be multiple natural choices. Other units may be chosen for Z as well but one skilled in the art will appreciate that this may require ‘quanto’ corrections to the yield formulas given below.

The scale factor will often be chosen to place the initial value of Z in a convenient range. For example, if the underlier is a U.S. stock with a value of roughly 100 U.S. dollars when the synthetic asset is created and the leverage is 2, the scale factor might be chosen as 0.01 so that the initial value of Z is also roughly 100 U.S. dollars. More generally a scale factor of roughly 100/(SO)^{L} will often prove convenient, where SO is the initial value of the underlier; analogous formulas apply in the multiple-underlier case.

The L's are the volatility and return leverage factors. Applying an L greater than 1 results in the volatility and size of return (for normal values of r, q, and σ) of asset Z being greater than the volatility and return of S substantially in accordance with the following formulas (for the single underlier case),

σ_{Z}Lσ,

q_{Z}L q+(1−L)r−½L(L−1)σ²,

with asset Z's delta and gamma being (irrespective of log-normality):

dZ/dS=L S^{L-1}=L Z/S

d²Z/dS²=L (L−1)S^{L-2}=L (L−1) Z /S².

Thus, the ratio of the instantaneous return on Z to the instantaneous return on S is:

dZ/Z/dS/S=S*dZ/dS/Z=S* delta/Z=L

De-Leveraging the Instantaneous Return and Volatility of an Asset

Similarly, the volatility and return of a log normal asset may also be de-leveraged according to the formulas above, when L is greater than 0 but less than 1. For example, consider the case where σ=50%, q=0 and r=5%. Such a case may be equivalent to a large technology stock (for example). If L is 0.8 then Z's volatility is 40% and corresponding yield is 3%. Thus, with the present invention, an investor who buys this synthetic asset receives a yield of 3% while modestly decreasing both his upside and downside exposure. An alternative investment strategy, for example, of buying only 0.8 shares of S and putting the rest of the money in the bank only yields 1%, 2% less than the de-leverage synthetic asset according to the present invention. Note that under this alternative, every time the value of S changes the investor would have to rebalance the position to maintain the 4:1 share value to cash ratio, with the attendant payment of trading costs.

Generally, the yield is maximum for

L=½−(r−q)/σ²,

or 0.3 for the above example. The corresponding volatility is 15% and the yield 6.125%, which is higher than the interest rate r. An alternative strategy of buying 0.3 shares of S and banking the difference only yields 3.5%.

The conversion of volatility into yield is maximum for L=½, resulting in a yield (for the above example) of 5.63%. In contrast, buying 0.5 shares of S and banking the rest yields only 2.5%. One skilled in the art will appreciate that in the present invention, the increased yield associated with volatility results from the potential for delta hedging the synthetic asset.

In this embodiment, delta decreases as S increases and the buyer of Z has a negative gamma when L is between 0 and 1, and conversely a positive gamma when L is either greater than 1 or less than 0 (the delta of Z, for L=0.8, is 0.8/S^{0.2}).

The selling of synthetic assets may also include provisions for unwinding of the synthetic asset if the value of S collapses. This is because as the value of S goes to zero, delta goes to infinity for L values less than 1. Accordingly, hedging of the synthetic asset is very difficult and nearly impossible under these conditions. However, for L being greater than 0, this is not necessarily an issue since the seller has a positive gamma and the liability goes to zero as S goes to zero. For L values near 1, however, the gamma is low so that on small positions, it is more difficult to realize the value of the gamma. In some cases a cap or floor on the value of Z might be contemplated instead of an unwind provision, but the unwind is preferable since a cap or floor is inconsistent with the constant leverage property.

Alternatively, in another embodiment of the present invention, de-leveraging may be reproduced (albeit in a complicated manner) by using options to approximate the Z payoff as a function of S, so that, in principle, the vega may be completely hedged (to a specific point in time) and the yield due to the investor received up front in the form of premiums on standard options.

A σ² yield on a constant notional resembles the floating leg of a variance swap. The synthetic asset may be regarded in part, then, as resembling a kind of variance swap, whose notional is the value of the asset and where the other leg of the swap is paid (in a “risk neutral world”) through expected capital depreciation of the synthetic asset relative to the real asset.

Another alternative for de-leveraging is a covered call; buying a share and simultaneously selling a call on the share. This decreases the leverage below one (1) while producing income in the form of an option premium. The yield on the de-leveraged synthetic asset may be regarded in some sense as due to constantly selling small short-term at-the-money calls.

These alternative strategies, however, are burdensome (as compared to the preferred embodiments of the present invention) since they require frequent rebalancing on a recurring basis to keep the leverage at the selected L, and the constant payment of commissions and other trading costs.

Leveraging Up

Having a value of L greater than one (1) results in asset Z having a volatility greater than the underlying asset S, where the yield of Z decreases and may become negative for modest increases in leverage. The buyer of the asset then pays a yield to the seller (if sold as a note, the synthetic asset might take the form of a zero coupon note sold at a premium).

The advantage of the synthetic asset having an upward leverage includes the property that the buyer's exposure may be continuously increased to the upside, while the buyer's downside exposure may be continuously decreased. Thus, no matter how high the leverage factor, the investor generally never loses more than his original investment, allowing the buyer to achieve leverages greater than one (1) without any margin considerations.

For example, the dollar value of the hedge (or S*delta) is proportional to the value of Z. Thus, for a leverage L>1, the number of hedge shares increases as the price of Z increases and decreases as the price of Z decreases. The opposite happens for a leverage value between 0 and 1 (but the dollar value of the synthetic asset still goes to zero as S goes to zero).

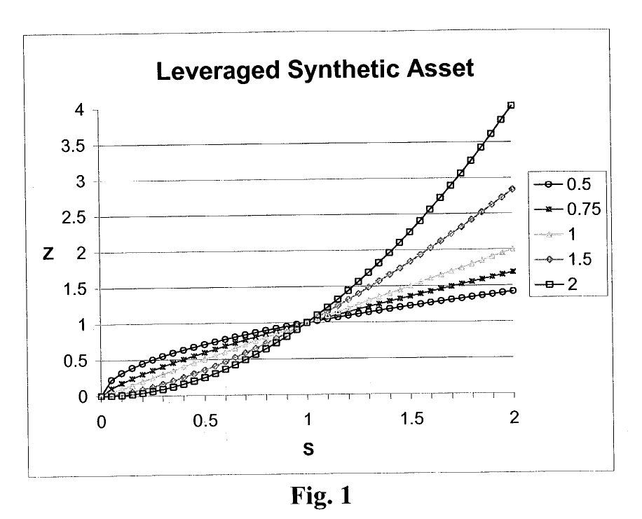

The payoff function for a leverage greater than one (1) (see FIG. 1) may be compared to that of a call at the purchase price prior to maturity, with the time-to-maturity for the comparable call depending on the leverage factor; the higher the leverage factor, the less time to maturity. Unlike a call, however, the “time-to-maturity” stays fixed rather than decreasing.

For example, consider a case where σ=30%, q=0, r=5%, L =2. Using the formulas according to the present invention, the yield is negative fourteen percent (−14%). Alternatively, if an investor bought one (1) share outright and one (1) share on margin, the buyer would be paying 5% (ignoring margin requirements). However in practice, the investor pays more than this. The synthetic asset is more expensive because it gains more rapidly on the upside than it loses on the downside. Roughly speaking, this may be compared to an investor constantly buying small calls. When the leverage is between 0 and 1, the effect is the opposite,—as the investor is, roughly, receiving extra yield as if he were constantly selling small calls.

Negative Leverage

An investor may obtain negative leverage in another embodiment of the invention using the following formula:

Z=1/S^{K}

where K is positive. Accordingly, the corresponding volatility and yield for log-normal underliers are

σ_{Z}=−K σ (the minus sign relates to a reversed sign for correlations and betas), and

q_{Z}=−K q+(1+K)r−½ K (K+1)σ²

Z's delta and gamma are

dZ/dS=−K/S^{K+1}=−K Z/S

d²Z/dS²=K (K+1)/S^{K+2}=K (K+1)Z/S²

The return leverage is −K.

The asset includes a negative delta, so the buyer has effectively shorted the underlying asset. Since gamma is generally always positive, the buyer usually would have to pay a yield to the seller. The negatively leveraged synthetic asset also includes a beta whose sign is opposite the sign of the underlying asset's beta. Because Z has unlimited upside as the value of S goes to zero, a seller of the synthetic asset may require that the asset be unwound if S falls to a predetermined value. Again it is impossible for the buyer to lose more than the original investment, so he can achieve negative leverage without any margin considerations.

For example, for S having σ=50%, q=0 and r=5%, where K=1, the yield is −15%. An alternative strategy for achieving this is by shorting one (1) share while simultaneously placing the dollar amount of one (1) share in the bank (since the investor must pay to buy the synthetic asset). The investor would earn 10% if the investor had unrestricted use of the shorting proceeds. However, in practice, because of margin requirements, he will earn much less than this. The reason for the large difference in yield is that the synthetic asset gains much more rapidly as the price of S falls than it loses as the price of S rises.

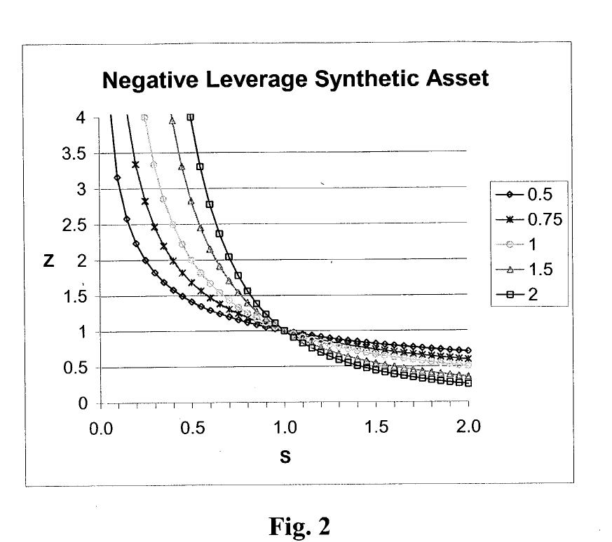

FIG. 2 illustrates the values of Z versus S for different values of K (for example).

The Leverage Spectrum

The cases of L=0 and L=1 correspond to cash and a share, respectively. Cash has a volatility of zero (0) and pays a yield of r, a share has a volatility of σ and pays a yield of q. Reviewing the formulas above for cases where 0<L<1 illustrates that volatility and part of the yield of the synthetic asset vary linearly with L between the cash and share cases as might be expected. However, the synthetic asset pays an additional yield due to the monetization of volatility. Thus, for leverage values between 0 and 1, the synthetic asset is intermediate between cash and a share, with an element of variance swap mixed in.

For leverage values greater than one (1) (L>1) the payoff of the synthetic asset may be compared to a call, with the higher the leverage L, the more of a similarity it may be to a call. As the leverage approaches infinity, the synthetic asset becomes a call on an infinite number of shares struck at one (1). Thus, for L>1, the synthetic asset is intermediate between a share and a call. A negative yield from the σ² term may be regarded as due to the effective call premium.

For a leverage value less than zero (L<0) the payoff of the synthetic asset may be compared to a put. Thus, when leverage approaches negative infinity, the synthetic asset becomes a put on an infinite number of shares struck at one (1). Thus, for leverage less than zero (0), the synthetic asset is intermediate between cash and a put. A negative yield from the σ² term may be regarded as due to the effective put premium.

Thus, constant leverage synthetic assets may allow a spectrum of novel financial instruments, and vastly expand the range of offerings to investors.

CSCO Example

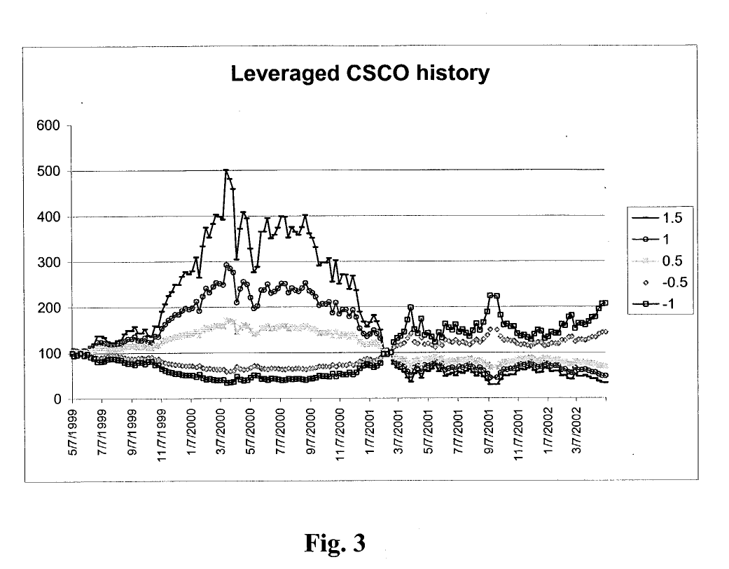

FIG. 3 illustrates three years of history for synthetic assets based on Cisco Systems Inc. (CSCO) with various leverages. The yields for σ=63.1%, q=0 and r=4% are illustrated in Table 1 below.

TABLE 1

| | | | | | |
|---|---|---|---|---|---|
| leverage | 0.5 | 1 | 1.5 | −0.5 | −1 |
| yield | 7.0% | 0.0% | −16.9% | −8.9% | −31.8% |

In general, leverage may be defined as the ratio of the fractional change in asset value to the fractional change in underlier value, or:

L=dV/V/dS/S=S*dV/dS/V=S*delta/V.

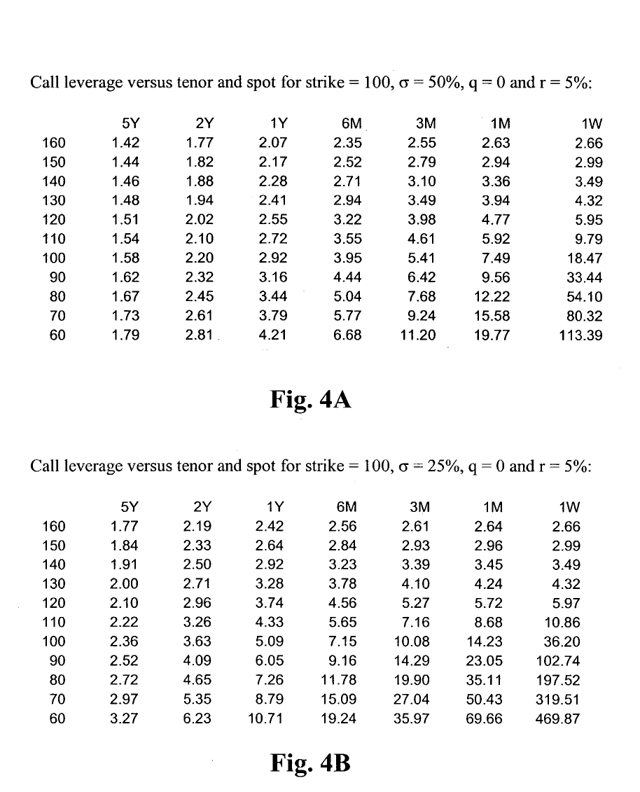

The last expression may be recognized as the ratio of the hedge value to the asset value. FIGS. 4A-4D illustrate the leverage for standard puts and calls on a stock as a function of time to expiry and spot. Accordingly, ordinary options have only modest leverage when the tenor is several years or they are deeply in the money (the leverages may be quite high otherwise). Note, as the investment loses money the leverage increases and as the investment gains money the leverage decreases, an undesirable feature shared by both buying and selling short on margin.

Removing the Price Drift

When sold in a simple form, a zero-coupon, fixed maturity security, constant leverage assets may trade at a premium (if the yield is negative) or at a discount (if the yield is positive) as compared to the “intrinsic” value of the asset (the value that may generally be received at maturity for the current value of spot). The premium/discount generally decreases with time and is zero at maturity. This may be undesirable for marketing synthetic assets according to the present invention, especially in a case where the security trades at a premium.

Accordingly, to address this, a time dependency may be introduced into the payoff function that cancels the drift in price. For example, suppose a zero-coupon security issued at time T₀ has a payoff of 100*(S/S₀)^{L} at time T, where S₀ is the value of S at T₀. Such a security will generally trade at e^{-y(T-t)} times the intrinsic value, where t is the current time and y is the yield of the asset. To avoid this the payoff function is instead chosen to be 100*(S/(S₀e^{-(y/L(t-T}_{₀}⁾))^{L} (for simplicity, it is generally assumed that y cannot change). The S₀e^{-(y/L)(t-T}_{₀}⁾ term may be described as the “break-even” point at time t, which changes with time to pay for the leverage. The security may then trade flat or nearly flat to the “intrinsic” value defined as 100*(S/S_{b.e.} (t))^{L}. The new factor may also be described as due to a redemption charge, or understood as adjusting the notional value of the asset over time, to pay for the leverage. One skilled in the art will appreciate that discrete dividends can be easily accommodated in S_{b.e.} and that the technique is also applicable with early exercise provisions.

Selling Synthetic Assets

The synthetic assets according to the present invention may be sold, for example, as a fixed term note (which may include an early redemption). The synthetic asset may also be sold as a perpetual security redeemable any time after a predetermined term. In the latter application, or even when sold with a lengthy fixed term, a seller may have the right to periodically adjust the yield as volatilities, interest rates and dividends change. In addition, the synthetic asset may be used as an underlier in other derivatives.

For certain synthetic assets, the discrete nature of dividends may be significant and can be taken into account in several ways. A transparent method for handling dividends is to use the formula relating Z to the value S of the underlying asset to compute the discrete dividend in Z corresponding to a discrete dividend in S by equating the total value before and after the dividend. This will generally approximate S's dividend multiplied by the leverage L. A second method for handling discrete dividends is to use the total return of the underlying asset S to compute the total return of Z. Yet a third method for handling dividends is to adjust the number of units of the synthetic asset Z to reflect the payment or receipt of discrete dividends. This effectively bases Z on the total return of S. In these cases, the synthetic asset still pays a continuous yield given by the formulas above with q=0. Adjusting the number of synthetic units in the synthetic asset to reflect the payment or receipt of both discrete and continuous dividends or yield effectively makes Z a total return asset. Note that in the case of negative leverage, the first method requires that a payment be made by, rather than to, the owner of the synthetic asset, similar to the situation in a short sale in a margin account.

Adjustable Leverage Account

In one embodiment of the present invention, synthetic assets according to the previous embodiments may be sold through a novel investment account/product. Specifically, such an account may be an Adjustable Leverage Account where an investor places money into an account, allocates the money to particular underlying stocks or other assets and specifies initial leverages. The investor may, for example, pay a commission proportional to the size of the initial leverages. Alternatively, or in addition to a commission, the investor may pay an account fee. The account may also require a minimum balance to be maintained.

Every day (or at the close of a trading period, for example) the account is debited or credited an appropriate amount for the leverage (e.g., usually, credited for leverages between 0 and 1, and debited for leverages greater than 1 or less than 0) and any dividends to be received or paid. The debits and credits may be carried out through an associated cash balance or by adjusting the number of units of the synthetic assets owned by the investor. At the end of the day, the account is adjusted to reflect the change in the value of the synthetic assets. The ability of the account provider to charge for leverage on a daily basis is a significant advantage over selling synthetic assets in a security form where the leverage charges for the whole term of the security must be effectively prepaid at the time of purchase. The account also offers more convenient handling of dividends than does a security.

The investor may change the allocations and leverages at any time, paying a commission proportional to the size of the changes in leverage. In addition, higher commissions may be charged for immediate execution as opposed to end-of-day execution, or, alternatively, the investor might be charged a simple account fee based on the total account value and allowed to change leverages and allocations freely.

Since the investor may never lose more than the account value, margin is never involved. However, a broker may seek to place consideration in restricting the allowed leverages according to the sophistication and risk profile of the investor. The broker may also reserve the right to limit the amounts invested—especially in negative leverages.

An advantage of the present invention is the unique ability to totally separate the decision of how much money to allocate to a particular stock and the decision on how much leverage is desired on that stock. The leverage can be changed either up or down at any time without having to move funds around. To simplify administration and risk management, the leverages may be restricted, for example, to a discrete set of values (e.g. multiples of, say, 0.25). The account may also be wrapped inside a fund family or tax-deferred vehicle.

Synthetic assets based on two (or more) underliers may also be available under the account, with the additional requirements of specifying the benchmark asset and benchmark leverage. The benchmark asset choices might be limited to a small number of major indices, sector indices, or bellwether stocks.

While the cost of leverage greater than 1 or less than 0 can be high, it is interpretable as due to an asymmetric payoff that is in the investor's favor—the investor loses less rapidly if he is positioned against the market than he gains if he is positioned with the market. Thus the investor has built-in protection against adverse moves. Indeed, this is ultimately why the investor may never lose more than his original investment no matter what the leverage.

Leverage other than 0 or 1 ultimately entails risk to the supplier. Because of this there may be a limited capacity to provide leverage and the broker providing these accounts may reserve the right to adjust the magnitude of leverage as necessary to control his risk. Beyond this, the broker may control his risk in the way traditional with any scarce resource: through pricing.

In this case, for example, pricing is the rate the broker charges (or pays in the de-leveraged case) for the leverage. One method for accomplishing this may include changing the rates on a periodic basis, and may also include providing a means for investors to lock in rates for fixed terms.

One risk to the leverage supplier is the gamma, which has the opposite sign for leverages between 0 and 1, as compared to the cases where L is greater than 1 or less than 0. This raises the possibility of internal hedges between the de-leveraged case and the leverage-up and negative leverage cases on the same underlier. Pricing may again be used to encourage internal hedging. However, the gamma for L=0.5 is eight (8) times smaller than the gamma for L=2 or −1, and thus, de-leveraged investments may be potentially eight (8) times the leveraged investments. To fully offset the risk in this case, it may be desirable to sell more positive leverage than negative leverage on the same underlier, so that the net hedge is positive and there would be no need to sell short on a market downtick.

For example, in an ordinary brokerage account, one may purchase an arbitrary mix of assets: 100 shares of IBM, 200 shares of MSFT, leave some money in cash, short positions (in a margin account) and the like. An adjustable leverage account according to the present invention is similar except that one can have constant leverage assets as well as ordinary assets (e.g. 100 synthetic units of IBM at L=1.5, 200 synthetic units of MSFT at L=2 and the like). The total value of the account is the collection of individual positions each of which is given by a constant leverage formula Z=S^{L} as applied to each position. The unique feature of the account is that when a new position is added, the buyer determines not only how much cash to invest in the asset, but also the leverage, which may be changed without changing the amount invested.

In one embodiment of the present invention, each constant leverage position is a target (benchmark) for a manager of the account rather than an exactly guaranteed payoff formula. Thus, a value Z may be targeted for the asset in accordance with the Z=S^{L}. Again, each position is separately targeted by a single constant leverage formula and the total account value could be regarded as a target too. Accordingly, the value of the account is the sum of all the individual targets:

Z_{account}=Z₁+Z₂+. . .+Zₙ, where Zₙ=Aₙ*Sₙ^{Ln},

where Sₙ is equal to the value of a corresponding underlying asset, Lₙ is a constant leverage value of the corresponding position, and Aₙ is the number of units of the corresponding position. The target value may be adjusted over time for the expected cost of leverage, which may include adjusting the A's or including an explicit cost of leverage item in the account, for example.

The manager of such an account may choose to target the desired Z value by holding a hedge portfolio of financial instruments whose value is expected to closely track the value of Z. This portfolio may contain, for example, some amount of the underlying assets, derivatives thereof, and money market instruments.

Thus, if a manager of the account were to target a Z value dependent on a particular S, the manager would need to adjust the amount of one or more of the hedge portfolio constituents to meet the target. Accordingly, targeting a particular value Z may include determining a first delta value for this S corresponding to a chosen target value Z for the account, determining a second delta value of the actual holdings at a particular time (e.g., several times per day), and comparing the second delta value with the first delta value. If the second delta value were outside a predetermined range, for example, of the first delta value, then the manager would adjust positions (by, for example, purchasing and/or selling shares or derivatives of S), to get to a delta value that is within the predetermined range. A similar embodiment may be included in an account which uses a benchmark asset (discussed further below). Accordingly, the value Z of the account would equal:

Z_{account}=Z₁+Z₂+. . . Zₙ, where Zₙ=Aₙ*Sₙ^{Ln}/Bₙ^{Kn},

where Sₙ is equal to the value of a corresponding underlying asset, Lₙ is a constant leverage value of the corresponding underlying asset, An is the number of units of the corresponding position, Bₙ is the value of a corresponding benchmark asset and Kₙ is a constant negative leverage value for the benchmark asset.

One of skill in the art will appreciate that the term “targeting” is any attempt to produce the value give by the formula using any means, or by engaging in trades in the underlying asset(s) and/or derivatives thereof.

The advantage of targeting Z rather than exactly guaranteeing it is that in the former case the provider of the account has no liability should he fail to meet the target. This would allow him to provide greater amounts of leverage than if the provider were required to cover any shortfall out of his own capital.

Time-Varying Leverage

Leveraging according to the present invention may also be employed in other ways according to other embodiments of the invention. For example, a structure may be set up in which leverage may change with time according to a predetermined rule (e.g. increase leverage in up markets and decrease it or make it negative in down markets). Another possibility may be allowing the investor in a structure to specify leverage changes at certain times. The net return for such time-varied leverage schemes may be computed simply by compounding the returns in the different intervals—log-normality is substantially preserved for log-normal underliers.

For example (similar to a momentum investing strategy), an investment may start with a leverage of 1, switch to a leverage of −1 if the underlying asset (or a market index) fell by a prescribed amount, and switch back to 1 if the underlying asset or market rose by a prescribed amount. In a structure with N periods, the final value will equal the initial value times (1+(Z_{E1}−Z_{B1})/Z_{B1}) *. . .* (1+(Z_{EN}−Z_{BN})/Z_{BN}) where the Z's are the values at beginning and end of the periods. Multi-period structures might allow leverage changes at the start of each period. Unwind provisions may also be included. The pricing of such a structure may need to take into account the transaction costs associated with adjusting the hedge as the leverage changed. This may be done using a Monte Carlo simulation, for example.

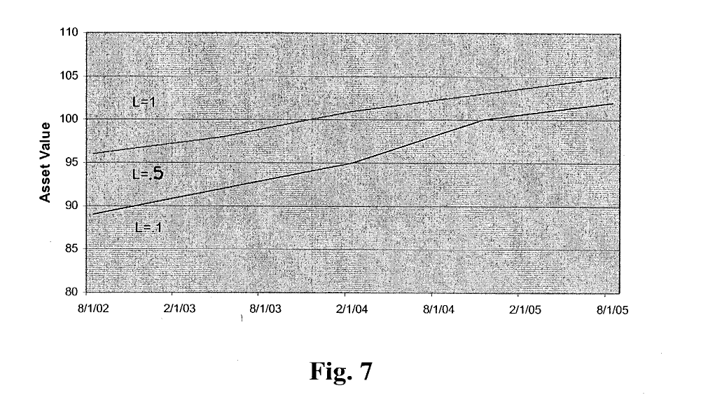

Another application of time-varying leverage cuts leverage as the value of the synthetic asset falls in order to provide downside protection. Accordingly, as shown in FIG. 7, three possible leverages (1, 0.5 and 0.1), separated by “barriers” in the asset value are shown. At the end of each trading session, the asset value is examined to determine which leverage applies for the next day. This method may also be varied, such as, less frequent resets or using a different rule for setting the new leverage from the asset value. For example, such a rule may include using a linear relationship with minimum and maximum values, where the minimum/maximum and slope depend on the reset date. Principal-protected synthetic asset structures based on this asset may be generally less costly since the synthetic asset has downside protection built in due to the de-leveraging.

Simultaneous Constant Leverage Against a Target and Benchmark Asset

In this embodiment, S is a target asset and B is a benchmark asset, both log-normally distributed with volatilities and dividends σ_{S}, σ_{B}, σ_{S}, σ_{B} and including a correlation factor ρ. Assume both are denominated in the same currency, having an associated interest rate of r. One of skill in the art will appreciate that it is not necessary that both the target asset and benchmark asset be denominated in the same currency, and it is also not necessary that both be in the same asset class (stock, foreign exchange rate, etc.). In a cross-currency case, ‘quanto’ adjustments to the yield may come into play.

Accordingly, the formula for the synthetic asset according to this embodiment is:

Z=S^{L}/B^{K}.

In earlier embodiments, the present invention presented both S and B terms separately. This embodiment using target and benchmark assets includes a new element—a cross-gamma from combining them. This adds a yield term related to the covariance between S and B. The cross-gamma will allow simultaneous manipulation of both the volatility of Z and its correlation (or beta) with B, with the value of these manipulations being transferred into the yield. One skilled in the art will appreciate that the value of Z then has an aspect of outperformance (for both L and K positive)—the value of Z goes up either if S increases or if B decreases, with independent leverage on both effects. Alternatively, if the role of S and B as numerator and denominator are swapped then the aspect becomes underperformance.

In the embodiment the volatility and yield of Z are

σ_{Z}=(L²σ²_{S}+K² σ²_{B}−2 L K ρσ_{S} σ_{B})^{1/2}, and

q_{Z}=L q_{S}−K q_{B}+(1+K−L)r−½L(L−1)σ²_{S}−½K(K+1)σ²_{B}+L K ρσ_{S} σ_{B},

with the correlation between Z and B being

ρ_{Z}=(L ρσ_{S}−K σ_{B})/σ_{Z}.

The deltas and gammas are (irrespective of log-normality)

dZ/dS=L S^{L-1}/B^{K}=L Z/S,

d²Z/dS²=L(L−1)S^{L-2}/B^{K}=L(L−1)Z/S²,

dZ/dB=−K S^{L}/B^{K+1}=−K Z/B,

d²Z/dB²=K(K+1)S^{L}/B^{K+2}=K(K+1)Z/B², and

d²Z/dSdB=−L K S^{L-1}/B^{K+1}=−L K Z/(S B).

The instantaneous return leverages against the target and benchmark are L and −K respectively.

Accordingly, there are four pieces of information the investor generally needs to specify for this asset: the target, the benchmark, the target leverage, and the benchmark leverage. The benchmarks may be limited to a relatively small set of major indices, sector indices, and bellwether stocks. Rather than specifying the target and benchmark leverage, the investor may be allowed to specify a net leverage (defined as the ratio of the synthetic asset volatility to the target asset volatility) and a degree of beta reduction (or the synthetic asset beta). Once the net leverage and beta are specified, the appropriate target and benchmark leverages may be calculated automatically.

The effect of the cross-gamma is that a positive ρ decreases the volatility and increases the yield of synthetic asset Z. The σ² terms may potentially be laid off at least partially in the market but the cross-gamma (or correlation risk) generally cannot and may need to be conservatively priced. The term involving ρ may be thought of as a kind of covariance swap. Accordingly, a covariance swap market may develop for this embodiment to allow hedging. Some hedging may also be achievable with ordinary outperformance options.

Because there are two leverages to adjust, the volatility of the synthetic asset Z and its correlation with the benchmark B may be simultaneously manipulated to engineer different synthetic assets. For example, ρ_{Z}=0 is reached when K/L=ρσ_{S}/σ_{B}. However, ρσ_{S}/σ_{B}=β_{S}, using a common definition of β. Thus β_{Z}=0 is achieved when L/K=1/β_{S}. In this case synthetic asset Z is market neutral and represents a pure play on the non-systematic component (or alpha) of underlying asset S (assuming the future β_{S}, σ_{S} and σ_{B} are substantially the same as historical values). Accordingly, market neutral assets may show capital appreciation even in a bear market as long as the target asset outperforms the benchmark (after leveraging). Market neutrality only constrains the ratio of L and K—yield may still be maximized, or the volatility of Z or one of the return leverages may be set to a corresponding desired level, by (for example) changing L and choosing K appropriately.

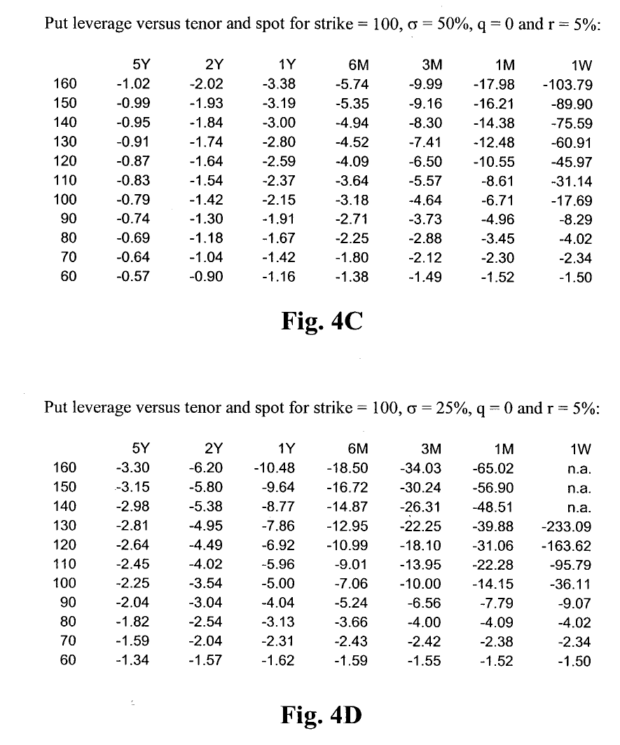

FIG. 5 illustrates a table showing market-neutral examples for σ_{S}=50%, q_{S}=0, σ_{B}=20%, q_{B}=1.5%, r=5%. The cross-yield value is the part of the yield attributable to the cross-gamma, which may be conservatively priced (or the risk passed on to the investor as described below). Funding is that part of the yield due to interest rates and dividends only.

Thus, when β_{S} is high, the possible yields are also very high. However, much of this stems from cross-gamma. Even low values of K may be attractive for an investor since pricing the correlation at half the nominal value may still provide a yield of around 6% with K˜1 and L˜1/β (i.e. S is leveraged down by β).

Accordingly, yield is maximized when

$$\begin{matrix}L = \frac{1}{1 - {ρ}^{2}} [ \frac{1}{2} ( 1 - ρ \frac{{σ}_{B}}{{σ}_{S}} ) - \frac{r - {q}_{S}}{{σ}_{S}^{2}} + ρ \frac{r - {q}_{B}}{{σ}_{S} {σ}_{B}} ] \\ K = \frac{1}{1 - {ρ}^{2}} [ \frac{1}{2} ( ρ \frac{{σ}_{S}}{{σ}_{B}} - 1 ) + \frac{r - {q}_{B}}{{σ}_{B}^{2}} - ρ \frac{r - {q}_{S}}{{σ}_{S} {σ}_{B}} ]\end{matrix}$$

For a fixed L, yield is maximized when

$$K = ρ \frac{{σ}_{S}}{{σ}_{B}} L - \frac{1}{2} + \frac{r - {q}_{B}}{{σ}_{B}^{2}}$$

For fixed K, yield is maximized when

$$L = ρ \frac{{σ}_{B}}{{σ}_{S}} K + \frac{1}{2} - \frac{r - {q}_{S}}{{σ}_{S}^{2}}$$

For K=βL yield is maximized when

$$L = \frac{{σ}_{S}^{2} / 2 - {βσ}_{B}^{2} / 2 + {q}_{S} - β {q}_{B} + ( β - 1 ) r}{{σ}_{S}^{2} + {β}^{2} {σ}_{B}^{2} - 2 β {ρσ}_{S} {σ}_{B}}$$

The L and K values for the maximum yield at a fixed σ_{Z} may be found by employing a suitable numerical optimization application. Such an application may also be used to incorporate additional constraints, such as keeping either or both of L and K in specific regions.

Maximum monetization of volatility and covariance may be found using the methods above with the funding parameters set to zero.

Market-neutral assets may provide better “outperformance” characteristics than a difference payoff. Since a difference payoff is based on a fixed number of shares of each asset (chosen so that the notional ratio is correct at inception), the notional ratio of the two sides moves away from the original ratio as the asset values change. Market-neutral assets implicitly keep the original notional ratio (rebalancing is built in). Difference payoffs are also not log-normal and therefore usually require special models (their unlimited downside might theoretically lead to “asset” values less than zero).

Market-neutral, negative-leverage assets (negative-alpha assets) or under-performance assets may be formed as well by choosing both L and K values less than 0 (i.e. the benchmark appears in the numerator and the target in the denominator). Generally, the investor may have to pay a yield on such assets, which, in some cases, may be less expensive than buying outright negative leverage on the target.

Risks—Consequences of Market Gaps

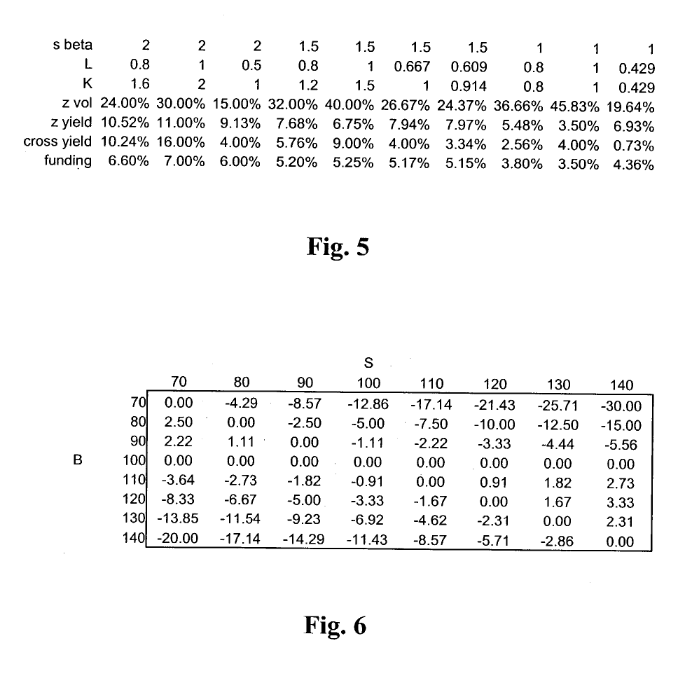

The table of FIG. 6 shows the profit/loss for a portfolio that contains a $100 short position in Z, plus delta hedges under the following scenario: L=K=1, S=B=100, and then the market gaps.

As shown, as long as S and B gap by the same percentage, there is little impact on the profit/loss. The negative gamma on B is offset by the cross-gamma if S and B move together. A drawback to this product, however, is correlation risk, but correlation affects the volatility and yield of the synthetic asset in opposite ways. If the synthetic asset is used as the underlier in another derivative whose vega and yield sensitivity have the same sign, then the correlation risk is reduced.

Another way to remove the correlation risk from this product is to pass it along to the investor. Rather than guaranteeing the investor a fixed yield, the seller pays him a floating rate based on realized volatility and covariance according to the yield formula above, and possibly guaranteeing a minimum yield.

Time-Varying Beta Adjustments

Multiple-period financial products like Salomon Smith Barney's TARGETS also offer the possibility of using a different underlier in each period. For example, switching between the return of a real stock and the return of a market-neutral or market-outperformance asset (with, for example, leveraging, e.g. back to the original asset volatility) based on the same stock depending on whether the market was up or down at the beginning of the period, relative to either the beginning of the deal or the previous period. This introduces a form of downside protection: bet on the stock when the market is going up but hedge the bet by switching to outperformance in a down market. This plays to a view that the stock is fundamentally sound but may be dragged down by the broad market. This may be an attractive alternative to adding more traditional downside protection (e.g. floors) to structures such as TARGETS, as these tend to be expensive for the investor. It also lowers the correlation risk, as the underlier may only be the synthetic asset roughly half the time. The underlier schedule may also be fixed in advance. An even more aggressive strategy may be to switch to negative leverages in a down market.

More generally, one could switch on beta adjustments at times other than the start of a predefined period, perhaps when a predetermined downside limit is reached. This is analogous to the time-varying leverages discussed in earlier embodiments. The returns of the various subintervals are simply compounded to get the return for larger intervals (log-normality is preserved for log-normal underliers). For example, one may sell a share forward or a call on a share and switch on a beta adjustment (and perhaps some leveraging, e.g. back to the original asset volatility) if the share or a market index falls below a predetermined level. This again offers an inexpensive downside protection. Pricing structures with time-varying beta adjustments may need to take into account the transaction costs associated with adjusting the hedge, however.

Structures such as TARGETS may also be used with a synthetic “underlier” based on a difference rather than a ratio, with the notionals rebalanced at the start of every period. However the ratio underlier may provide both a higher coupon and less correlation risk in this structure. In addition, the difference “underlier” is also not log-normal and may become zero or lose more than 100% of the investment.

Alternative Embodiments

The embodiments of the present invention may be constructed from any number of real assets by multiplying them together with either positive (target assets which appear in the numerator of the payoff) or negative (benchmark assets which appear in the denominator of the payoff) leverages. The additional leverages may be used to simultaneously adjust the volatility of the synthetic asset and its beta or correlation against additional assets. If there are N assets, there are also N leverages and N properties may be adjusted, (e.g. the volatility plus N−1 correlations). There will always be one remaining property that reflects the adjustments, in this case the yield.

The methods, products and investment accounts according to the present invention may be operated in conjunction with computer system embodiments which allow investors, brokers, fund managers and the like to create synthetic assets and/or purchase positions in synthetic assets or hedge such positions. Accordingly, the present invention may be used with established computer systems, networks, servers, databases, workstations and the like, which are used in the financial industry today.

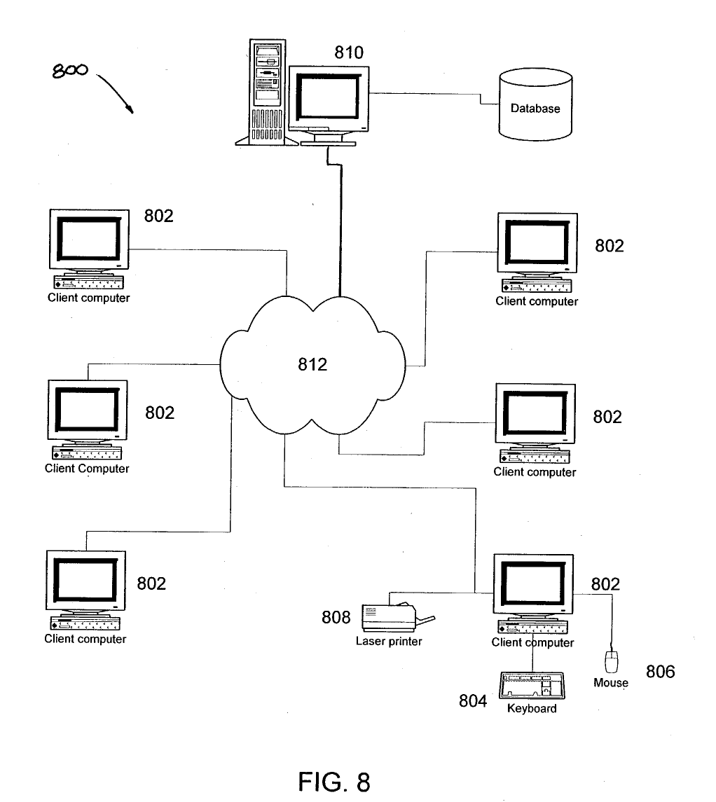

FIG. 8 illustrates, as an example, a general, high-level overview of a client/server computer system 800 which may incorporate the methods, systems and products according to embodiments of the present invention. Accordingly, a user operating a workstation 802 may access a brokerage account (for example) operating on a host server 810. The communication between the workstation and the server may be via the Internet 812, or any other communicating methods (both wired and wireless). Such access to the brokerage account may be via a web-page on the World-Wide-Web using a web-browser.

The workstation may include any number of peripheral devices (e.g. printer 808, display, loudspeaker) and input means including a keyboard 804, a mouse 806, a touchscreen, a microphone, a bar code reader (not shown), and the like. The workstation, of course, also includes general and specific computer hardware and software (e.g. memory, hard drives, CD-ROM, soundboard, graphics and the like; software: operating system, application programs, databases and the like) to perform the various functions in processing and communication information.

The host server may be networked with other computers/servers and the like, for communicating and storing information on database servers, and for accessing different information for performing the methods according to the present invention.

Thus, investors, brokers and fund managers need only operate a web-browser on a workstation to access a host server for performing the various method embodiments of the present invention. One of skill in the art will appreciate that customized application and database software may be produced to perform the methods according to the present invention and that workstations may include a wireless device such as a PDA, cell phone or other wireless communication device which may communicate with a computer network.

Having now described a few embodiments of the invention, it should be apparent to those skilled in the art that the foregoing is merely illustrative and not limiting, having been presented by way of example only. Numerous modifications and other embodiments are within the scope of ordinary skill in the art and are contemplated as falling within the scope of the invention as defined by the appended claims and equivalents thereto. In addition, within the scope of the present invention are the use of existing financial products, instruments and derivatives to approximate a constant leverage. The contents of any references cited throughout this application are hereby incorporated by reference. The appropriate components, processes, and methods of those documents may be selected for the present invention and embodiments thereof.

Appendix A—Geometric Brownian Motion

A stochastic variable X representing an asset price is said to undergo geometric Brownian motion if it follows the process

dX/X=μdt+σdz,

where dz is a standard Brownian motion and μ and σ may be functions of time and state variables (including X). Risk neutrality requires that μ=r−q where r is the applicable risk-free interest rate and q is the yield of the asset. The leveraged volatility and yield formulas cited above follow immediately from applying Ito's lemma. The essential results may also apply to other stochastic processes (e.g. Ornstein-Uhlenbeck or jump diffusion). The terms “log-normal asset”, “log-normal distributed asset” or “log-normally distributed asset” above refers to assets whose prices are commonly or usefully modeled as undergoing geometric Brownian motion.

What is claimed is:

1. A synthetic asset comprising a first underlying asset having a value S, wherein an instantaneous value Z of the synthetic asset is substantially in accordance with the formula Z=S^{L}, where L is neither 0 nor 1 and L is substantially constant over a period of time.

2. A synthetic asset comprising an underlying asset having a value S and a plurality of financial derivatives thereof, wherein an instantaneous value Z of the synthetic asset is substantially in accordance with the formula Z=S^{L}, where L is neither 0 nor 1 and L is substantially constant over a period of time.

3. A synthetic asset comprising an underlying asset having a value S and a benchmark asset having a value of B, wherein an instantaneous value Z of the synthetic asset is substantially in accordance with the formula Z=S^{L}/B^{K}, wherein neither L nor K is 0, the absolute value of either L or K differs from 1 and wherein L and K are substantially constant over a period of time.

4. The synthetic asset according to any of claims 1-3, wherein all underlying assets comprise a substantially log-normally distributed asset.

5. The synthetic asset according to claim 1, wherein the delta of the synthetic asset with regard to the underlying asset is substantially in accordance with the formula δ=L*Z/S.

6. The synthetic asset according to claim 1, wherein the gamma of the synthetic asset with regard to the underlying asset is substantially in accordance with the formula γ=L*(L−1)*Z/S².

7. A synthetic asset comprising at least one first underlying asset with value S and at least one financial derivative of the first underlying asset, wherein an instantaneous value of the synthetic asset is substantially in accordance with the formula Z=S^{L}, where L is substantially constant and is neither 0 nor 1.

8. A method of leveraging the value of an asset comprising:
providing an underlying asset having a value S;
selecting a substantially constant leveraging factor L; and
associating an instantaneous value Z to the asset substantially in accordance with the formula Z=S^{L}, where L is neither 0 nor 1.

9. The method according to claims 7 or 8, wherein the underlying asset comprises a substantially log-normally distributed asset.

10. A method of creating a synthetic asset based upon applying a substantially constant leverage to the value of an asset comprising:
providing an underlying asset having an associated value S; and
applying a substantially constant leveraging factor L to the underlying asset to create a synthetic asset, wherein an instantaneous value Z of the synthetic asset is substantially in accordance with the formula Z=S^{L}, wherein L is different from 0 and 1.

11. The method according to claim 10, wherein the synthetic asset comprises the underlying asset and a plurality of financial derivatives thereof.

12. A method of creating a synthetic asset based upon applying substantially constant leverages to the values of a pair of assets comprising:
providing a first underlying asset, wherein the first asset includes an associated value S;
providing an underlying benchmark asset, wherein the benchmark asset includes an associated value B; and
applying a substantially constant leveraging factor L to the first asset and a substantially constant negative leveraging factor K to the benchmark asset to create a synthetic asset, wherein an instantaneous value Z of the synthetic asset is substantially in accordance with the formula Z=S^{L}/B^{K}, wherein neither L nor K is 0 and wherein the absolute value of either L or K differs from 1.

13. The method according to claim 12, wherein one or both underlying assets comprise a substantially log-normally distributed asset.

14. The method according to claim 12, wherein the delta of the synthetic asset with regard to the first asset is substantially in accordance with the formula δ=L* Z/S.

15. The method according to claim 12, wherein the gamma of the synthetic asset with regard to the first asset is substantially in accordance with the formula γ=L* (L−1)*Z/S².

16. The method according to claim 12, wherein the delta of the synthetic asset with regard to the benchmark asset is substantially in accordance with the formula δ=−K*Z/B.

17. The method according to claim 12, wherein the gamma of the synthetic asset with regard to the benchmark asset is substantially in accordance with the formula γ=K*(K+1)* Z/B².

18. The method according to claim 12, wherein the cross-gamma of the synthetic asset with regard to the first asset and the benchmark asset is substantially in accordance with the formula γ=(−L*K*Z)/(S*B).

19. A method of investing comprising:
providing an account having an amount of cash deposited therein by holder of the account;
allocating a portion of the cash for investing into at least one synthetic asset based on an underlying asset, wherein the underlying asset includes a value S; and
purchasing at least one synthetic asset with at least a portion of the allocated cash, wherein the synthetic asset includes an instantaneous value substantially in accordance with the formula Z=S^{L}, wherein L comprises a substantially constant leveraging factor which is neither 0 nor 1.

20. The method according to claim 19, further comprising selecting the value L.

21. The method according to claim 19, wherein the synthetic asset comprises a plurality of financial instruments

22. The method according to claim 21, wherein the plurality of financial instruments includes at least one of: the underlying asset, one or more derivatives of the underlying asset and one or more cash equivalents.

23. The method according to claim 19, further comprising paying a commission proportional to the magnitude of the initial leverage L.

24. The method according to claim 19, further comprising paying an account fee.

25. The method according to claim 19, wherein the account is adjusted an amount corresponding to the cost or yield for the leverage over a time period.

26. The method according to claim 19, wherein the account is adjusted an amount corresponding to a dividend paid by the underlying asset.

27. The method according to claim 19, further comprising changing the leverage of the synthetic asset to a second leverage.

28. The method according to claim 27, wherein upon changing the leverage, the method further comprises paying a commission proportional to the magnitude of the change in leverage.

29. The method according to claim 28, wherein the commission comprises a higher amount for an immediate execution of the change in leverage.

30. The method according to claim 19, wherein leverage values are selected from a discrete set of predetermined values.

31. The method according to claim 27, wherein the second leverage value is selected from a discrete set of predetermined values.

32. The method according to claim 19, further comprising automatically adjusting the leverage value based upon a predetermined rule.

33. The method according to claim 32, wherein the predetermined rule comprises increasing the leverage in an upward moving market.

34. The method according to claim 32, wherein the predetermined rule comprises decreasing the leverage in a downward moving market.

35. The method according to claim 33, wherein the upward moving market comprises an upward moving market index.

36. The method according to claim 34, wherein the downward moving market comprises a downward moving market index.

37. The method according to claim 32, wherein the predetermined rule comprises a predetermined event.

38. The method according to claim 32, wherein the predetermined rule comprises liquidating a portion of the synthetic asset upon S substantially reaching a threshold.

39. The method according to claim 38, wherein liquidating comprises reducing the leverage L to 1 when L is greater than 1.

40. The method according to claim 38, wherein upon L being initially less than 0, liquidating comprises setting L to 0.

41. The method according to claim 38, wherein upon L being initially between 0 and 1, liquidating comprises setting L to 0 upon L being within a predetermined first range of values between approximately 0 and 1, and setting L to 1 upon L being within a predetermined second range of values between approximately 0 and 1.

42. The method according to claim 19, wherein the underlying asset is selected from the group consisting of: stocks, equity indices, other log normally distributed indices, currency exchange rates, precious metals, commodities, bond prices and baskets of the preceding.

43. The method according to claim 19, wherein the cost or yield associated with the leverage is periodically adjusted.

44. The method according to claim 19, wherein the cost or yield associated with the leverage is periodically adjusted based upon a total demand in the underlying asset.

45. A synthetic asset comprising a first underlying asset having a value S and being leveraged by a substantially constant value L, wherein an instantaneous value of the synthetic asset is substantially in accordance with the formula Z=S^{L}, where L is neither 0 nor 1, and wherein the leverage is automatically increased in an upward moving market and automatically decreased in a downward moving market.

46. A method of creating a substantially log-normally distributed synthetic asset based upon applying substantially constant leverage to a value of a substantially log-normally distributed underlying asset comprising:
providing an underlying substantially log-normally distributed asset having an original volatility σ and an original yield q, wherein the asset includes an associated value S and interest rate r;
applying a substantially constant leveraging factor L, which is neither 0 nor 1, to the asset to produce:
a modified volatility σ_{Z} for the synthetic asset substantially in accordance with the formula σ_{Z}=L σ, and
a modified yield q_{Z} for the synthetic asset substantially in accordance with the formula q_{Z}=L q+(1−L)r −½L(L−1)σ²,
wherein an instantaneous value Z of the synthetic asset is substantially in accordance with the formula Z=S^{L}.

47. The method according to claim 46, wherein q_{Z} is maximized upon L being substantially equal to (½−(r−q)/σ²).

48. The method according to claim 46, wherein the contribution of volatility to q_{Z} is maximized upon L being substantially equal to about ½.

49. A method of creating a substantially log-normally distributed synthetic asset based upon applying substantially constant leverages to values of a pair of substantially log-normally distributed assets, comprising:
providing a first underlying substantially log-normally distributed asset having an original volatility σ_{S} and an original yield q_{S}, wherein the first asset includes an associated value S in a currency having an interest rate r;
providing an underlying substantially log-normally distributed benchmark asset having an original volatility σ_{B} and an original yield q_{B}, wherein the benchmark asset includes an associated value B in the same currency;
providing a correlation factor ρ between the first asset and the benchmark asset; and
applying a substantially constant leveraging factor L to the first asset and a substantially constant negative leveraging factor K to the benchmark asset to produce:
a modified volatility σ_{Z} for the synthetic asset substantially in accordance with the formula
σ_{Z}={(L²*σ²_{S})+(K²*σ²_{B})−(2*L*K*ρ*σ_{S}*σ_{B})}^{1/2}, and
a modified yield q_{Z} for the synthetic asset substantially in accordance with the formula
q_{Z}=(L*q_{S})−(K*q_{B})+((1+K−L)*r)−(½*L*(L−1)* σ²_{S})−(½*K*(K+1)* σ²_{B})+(L*K*ρ*σ_{S}*σ_{B})
wherein an instantaneous value Z of the synthetic asset is substantially in accordance with the formula Z=S^{L}/B^{K}, wherein neither L nor K is 0 and the absolute value of either L or K differs from 1.

50. The method according to claim 49, wherein a correlation factor ρ_{Z} between the synthetic asset and the benchmark asset is substantially in accordance with the formula ρ_{Z}=(Lρσ_{S}−Kν_{B})/σ_{Z}.

51. The method according to claim 49, wherein the yield q_{Z} is substantially maximized when L and K are substantially in accordance with the following respective formulas:
$$\begin{matrix}L = \frac{1}{1 - {ρ}^{2}} [ \frac{1}{2} ( 1 - ρ \frac{{σ}_{B}}{{σ}_{S}} ) - \frac{r - {q}_{S}}{{σ}_{S}^{2}} + ρ \frac{r - {q}_{B}}{{σ}_{S} {σ}_{B}} ] and \\ K = \frac{1}{1 - {ρ}^{2}} [ \frac{1}{2} ( ρ \frac{{σ}_{S}}{{σ}_{B}} - 1 ) + \frac{r - {q}_{B}}{{σ}_{B}^{2}} - ρ \frac{r - {q}_{S}}{{σ}_{S} {σ}_{B}} ] .\end{matrix}$$

52. The method according to claim 49, wherein the yield q_{Z} is substantially maximized for a substantially fixed L upon K being substantially in accordance with the formula:
$$K = ρ \frac{{σ}_{S}}{{σ}_{B}} L - \frac{1}{2} + \frac{r - {q}_{B}}{{σ}_{B}^{2}} .$$

53. The method according to claim 49, wherein the yield q_{Z} is substantially maximized for a substantially fixed K upon L being substantially in accordance with the formula:
$$L = ρ \frac{{σ}_{B}}{{σ}_{S}} K + \frac{1}{2} - \frac{r - {q}_{S}}{{σ}_{S}^{2}} .$$

54. The method according to claim 49, wherein the yield q_{Z} is substantially maximized upon L being substantially in accordance with the formula:
$$L = \frac{{σ}_{S}^{2} / 2 - {βσ}_{B}^{2} / 2 + {q}_{S} - β {q}_{B} + ( β - 1 ) r}{{σ}_{S}^{2} + {β}^{2} {σ}_{B}^{2} - 2 β {ρσ}_{S} {σ}_{B}}$$
upon K being substantially in accordance with the formula K=β*L.

55. The method according to any of claims 51-54, wherein the portion of the yield q_{Z} due to correlation and volatility is maximized upon applying the method with the values of r, q_{S} and q_{b} being substantially equal to zero.

56. The method according to claim 49, wherein the benchmark asset is selected from the group consisting of: major indices and sector indices.

57. A system for leveraging the value of an asset comprising:
a computer system in communication with a computer network, wherein the computer system presents an underlying asset having a value S; and
input means for selecting a substantially constant leveraging factor L, wherein an instantaneous value Z of the synthetic asset is substantially in accordance with the formula Z=S^{L}, wherein L is neither 0 nor 1.

58. The system according to claim 57, wherein the input means comprises at least one of: a keyboard, a microphone, a mouse, a trackpad, a touchscreen, a bar-code reader, a data file and a database.

59. A system for creating a synthetic asset based upon applying substantially constant leverages to the values of a pair of assets comprising:
a computer system in communication with a computer network, the computer system for presenting a first underlying asset, wherein the first asset includes an associated value S, and for presenting an underlying benchmark asset, wherein the benchmark asset includes an associated value B; and
input means for selecting a substantially constant leveraging factor L for the first asset and a substantially constant negative leveraging factor K for the benchmark asset, and wherein an instantaneous value Z of the synthetic asset is substantially in accordance with the formula Z=S^{L}/B^{K}, wherein neither L nor K is 0 and the absolute value of either L or K differs from 1.

60. The system according to claim 59, wherein the input means comprises at least one of: a keyboard, a microphone, a mouse, a trackpad, a touchscreen, a bar-code reader, a data file and a database.

61. A system for investing in an asset comprising:
a computer system in communication with a computer network, the computer system for presenting and/or interacting with an account having an amount of cash deposited therein by holder of the account; and
input means for allocating a portion of the cash for investment into at least one synthetic asset based on an underlying asset and/or for selecting a substantially constant leverage value L which is neither 0 nor 1, wherein the underlying asset includes a value S, the synthetic asset is purchased with at least a portion of the allocated cash, and the synthetic asset includes an instantaneous value substantially in accordance with the formula Z=S^{L}.

62. The system according to claim 61, wherein the input means comprises at least one of: a keyboard, a microphone, a mouse, a trackpad, a touchscreen, a bar-code reader, a data file and a database.

63. A system for investing in an asset comprising:
a computer system in communication with a computer network, the computer system for presenting and/or interacting with an account having an amount of cash deposited therein by holder of the account; and
input means for allocating a portion of the cash for investment into at least one synthetic asset based on an underlying asset and a benchmark asset, and/or for selecting substantially constant leverage factors, wherein the underlying asset includes a value S, the synthetic asset is purchased with at least a portion of the allocated cash, and the synthetic asset includes an instantaneous value substantially in accordance with the formula Z=S^{L}/B^{K}, wherein L is a substantially constant leverage factor, B is a value associated with the benchmark asset, and wherein K is a substantially constant negative leveraging factor, wherein neither L nor K is 0 and the absolute value of either L or K differs from 1.

64. A synthetic asset comprising a financial derivative of an underlying asset having a value S, wherein the synthetic asset includes a value at time t substantially in accordance with the formula Z=(S/S_{BREAK-EVEN}(t))^{L}, wherein L is a leverage value different from 0 and 1.

65. The synthetic asset according to claim 64, wherein S_{BREAK-EVEN}(t)=S₀e^{-(y/L)(t-T}₀⁾.

66. A multi-period compound synthetic asset comprising an underlying asset and/or a financial derivative thereof, the underlying asset having a value S and being leveraged by a substantially constant value L during each period, wherein the return of the synthetic asset during each period is substantially in accordance with the difference between a second Z value of the synthetic asset at the end of the period and a first Z value at the beginning of the period divided by the first Z value, wherein Z is substantially in accordance with the formula Z=S^{L}, wherein the total return of the synthetic asset is the compounded return of the distinct periods, and where L is potentially neither 0 nor 1 in at least one period.

67. The multi-period synthetic asset according to claim 66, wherein L differs from period to period.

68. The multi-period synthetic asset according to claim 66, wherein the underlying asset S is selected in each period in accord with a predetermined rule and L is potentially different from 1 in at least one period.

69. The multi-period compound synthetic asset according to claim 66, wherein L is selected in each period in accord with a predetermined rule.

70. The multi-period synthetic asset according to claim 66, wherein the synthetic asset is used as an underlier in another financial derivative.

71. A multi-period synthetic asset comprising a pair of underlying assets, wherein the return of the synthetic asset during each period is substantially in accordance with the difference between a second value Z of the synthetic asset at the end of the period and a first value Z at the beginning of the period divided by the first value Z, wherein Z is substantially in accordance with the formula Z=S^{L}/B^{K}, wherein the total return of the synthetic asset is the compounded return of the distinct periods, wherein L is substantially constant during each period and may be different from 1 in one or more periods, and K is substantially constant during each period and may be different from 0 in one or more periods and wherein either or both of L and K may change in at least one period.

72. The multi-period synthetic asset according to claim 71, wherein the synthetic asset is used as an underlier in another financial derivative.

73. A method of managing an investment account comprising:
allocating an amount of cash in an investment account for purchasing one or more position in one or more underlying assets and/or derivatives thereof;
purchasing at least one such position for the account with the allocated cash; and
targeting a value Z of each position of the account substantially in accordance with the formula Z=A*S^{L}, wherein each value of S is substantially equal to the value of the corresponding underlying asset, L is a substantially constant leverage factor for the corresponding position, and wherein A is the number of units of the corresponding position.

74. The method according to claim 73, wherein targeting comprises:
determining a first delta value corresponding to a targeted value Z for a position in the account;
determining a second delta value of the holdings for the position; and
comparing the second delta value with the first delta value.

75. The method according to claim 74, wherein upon the second delta value being outside a predetermined range of the first delta value, the method further comprises purchasing positions in the corresponding underlying asset and/or derivatives thereof to produce a third delta value of the position, wherein the third delta value is within the predetermined range.

76. The method according to claim 73, wherein the leverage changes according to a predetermined rule.

77. A method of managing an investment account comprising:
allocating an amount of cash in an investment account for purchasing one or more positions in one or more underlying target or benchmark assets and/or derivatives thereof;
purchasing at least one such position for the account with the allocated cash; and
targeting a value Z of each position of the account substantially in accordance with the formula Z=A*S^{L}/B^{K}, wherein S is substantially equal to the value of a corresponding target asset, L is a substantially constant leverage factor for the corresponding target asset, A is the number of units of the corresponding position, B is the value of a corresponding benchmark asset and wherein K is a substantially constant negative leverage factor for the benchmark asset.

78. The method according to claim 77, wherein at least one of the leverages change according to a predetermined rule.

79. The method according to claim 77, wherein targeting comprises:
determining a first delta value corresponding to a targeted value Z for a position in the account;
determining a second delta value of the holdings for the position; and
comparing the second delta value with the first delta value.

80. The method according to claim 79, wherein upon the second delta value being outside a predetermined range of the first delta value, the method further comprises purchasing positions in the corresponding underlying target or benchmark asset and/or derivatives thereof to produce a third delta value of the position, wherein the third delta value is within the predetermined range.

81. A computer readable medium including computer instructions provided thereon for enabling a computer system to perform a method of leveraging the value of an asset, the method comprising:
providing an underlying asset having a value S;
selecting a substantially constant leveraging factor L which is neither 0 nor 1; and
associating an instantaneous value Z to the leveraged asset substantially in accordance with the formula Z=S^{L}.

82. A computer application program operational on a computer system for performing a method of leveraging the value of an asset, the method comprising:
providing an underlying asset having a value S;
selecting a substantially constant leveraging factor L which is neither 0 nor 1; and
associating an instantaneous value Z to the leveraged asset substantially in accordance with the formula Z=S^{L}.

83. A computer readable medium having computer instructions provided thereon for enabling a computer system to perform a method of creating a synthetic asset based upon applying substantially constant leverages to the values of a pair of assets, the method comprising:
providing a first underlying asset, wherein the first asset includes an associated value S;
providing an underlying benchmark asset, wherein the benchmark asset includes an associated value B;
applying a substantially constant leveraging factor L to the first asset; and
applying a substantially constant negative leveraging factor K to the benchmark asset, wherein an instantaneous value Z of the synthetic asset is substantially in accordance with the formula Z=S^{L}/B^{K}, wherein neither L nor K is 0 and wherein the absolute value of either L or K differs from 1.

84. A computer application program operational on a computer system for performing a method of creating a synthetic asset based upon applying substantially constant leverages to the values of a pair of assets, the method comprising:
providing a first underlying asset, wherein the first asset includes an associated value S;
providing an underlying benchmark asset, wherein the benchmark asset includes an associated value B; and
applying a substantially constant leveraging factor L to the first asset;
applying a substantially constant negative leveraging factor K to the benchmark asset, wherein an instantaneous value Z of the synthetic asset is substantially in accordance with the formula Z=S^{L}/B^{K}, wherein neither L nor K is 0 and wherein the absolute value of either L or K differs from 1.

85. A computer readable medium having computer instructions provided thereon for enabling a computer system to perform a method of investing in an asset, the method comprising:
providing an account having an amount of cash deposited therein by holder of the account;
allocating a portion of the cash for investing into at least one synthetic asset based on an underlying asset, wherein the underlying asset includes a value S; and
purchasing the synthetic asset with at least a portion of the allocated cash, wherein the synthetic asset includes an instantaneous value substantially in accordance with the formula Z=S^{L} where L is a substantially constant leverage factor which is neither 0 nor 1.

86. A computer application program operational on a computer system for performing a method of investing in an asset, the method comprising:
providing an account having an amount of cash deposited therein by holder of the account;
allocating a portion of the cash for investing into at least one synthetic asset based on an underlying asset, wherein the underlying asset includes a value S; and
purchasing the synthetic asset with at least a portion of the allocated cash, wherein the synthetic asset includes an instantaneous value substantially in accordance with the formula Z=S^{L}, wherein L is a substantially constant leverage value which is neither 0 nor 1.

87. A computer readable medium having computer instructions provided thereon for enabling a computer system to perform a method of creating a substantially log-normally distributed synthetic asset based upon applying substantially constant leverage to a value of a substantially log-normally distributed asset, the method comprising:
providing an underlying substantially log-normally distributed asset having an original volatility σ and an original yield q, wherein the asset includes an associated value S and interest rate r; and
applying a substantially constant leveraging factor L to the asset to produce:
a modified volatility σ_{Z} for the synthetic asset substantially in accordance with the formula σ_{Z}=L σ, and
a modified yield q_{Z} for the synthetic asset substantially in accordance with the formula q_{Z}=L q+(1−L)r −½L (L−1) σ²,
wherein an instantaneous value Z of the synthetic asset is substantially in accordance with the formula Z=S^{L}, wherein L is neither 0 nor 1.

88. A computer application program operational on a computer system for performing a method of creating a substantially log-normally distributed synthetic asset based upon applying substantially constant leverage to a value of a substantially log-normally distributed asset, the method comprising:
providing an underlying substantially log-normally distributed asset having an original volatility σ and an original yield q, wherein the asset includes an associated value S and interest rate r; and
applying a substantially constant leveraging factor L to the asset which is neither 0 nor 1 to produce:
a modified volatility σ_{Z} for the synthetic asset substantially in accordance with the formula σ_{Z}=L σ, and
a modified yield q_{Z} for the synthetic asset substantially in accordance with the formula q_{Z}=L q+(1−L) r−½L (L−1) σ²,
wherein an instantaneous value Z of the synthetic asset is substantially in accordance with the formula Z=S^{L}.

89. A computer readable medium having computer instructions provided thereon for enabling a computer system to perform a method of creating a substantially log-normally distributed synthetic asset based upon applying substantially constant leverages to values of a pair of substantially log-normally distributed assets, the method comprising:
providing a first underlying substantially log-normally distributed asset having an original volatility σ_{S} and an original yield q_{S}, wherein the first asset includes an associated value S in a currency having an interest rate r;
providing an underlying substantially log-normally distributed benchmark asset having an original volatility σ_{B} and an original yield q_{B}, wherein the benchmark asset includes an associated value B in the same currency; and
providing a correlation factor ρ between the first asset and the benchmark asset;
applying a substantially constant leveraging factor L to the first asset and a substantially constant negative leveraging factor K to the benchmark asset to produce:
a modified volatility σ_{Z} for the synthetic asset substantially in accordance with the formula
σ_{Z}={(L²*σ²_{S})+(K²*σ²_{B})−(2*L*K*ρ*σ_{S}*σ_{B})}^{1/2}, and
a modified yield q_{Z} for the synthetic asset substantially in accordance with the formula
q_{Z}=(L*q_{S})−(K*q_{B})+((1+K−L)*r)−(½*L*(L−1)* σ²_{S})−(½*K*(K+1)* σ²_{B})+(L*K*ρ*σ_{S}*σ_{B})
wherein an instantaneous value Z of the synthetic asset is substantially in accordance with the formula Z=S^{L}/B^{K}, wherein neither L nor K is 0 and wherein the absolute value of either L or K differs from 1.

90. A computer application program operational on a computer for performing a method of creating a substantially log-normally distributed synthetic asset based upon applying substantially constant leverages to values of a pair of substantially log-normally distributed assets, the method comprising:
providing a first underlying substantially log-normally distributed asset having an original volatility σ_{S} and an original yield q_{S}, wherein the first asset includes an associated value S in a currency having an interest rate r;
providing an underlying substantially log-normally distributed benchmark asset having an original volatility σ_{B} and an original yield q_{B}, wherein the benchmark asset includes an associated value B in the same currency;
providing a correlation factor p between the first asset and the benchmark asset; and
applying a substantially constant leveraging factor L to the first asset and a substantially constant negative leveraging factor K to the benchmark asset to produce:
a modified volatility σ_{Z} for the synthetic asset substantially in accordance with the formula
σ_{Z}={(L²*σ²_{S})+(K²*σ²_{B})−(2*L*K*ρ*σ_{S}*σ_{B})}^{1/2}, and
a modified yield q_{Z} for the synthetic asset substantially in accordance with the formula
q_{Z}=(L*q_{S})−(K*q_{B})+((1+K−L)*r)−(½*L*(L−1)* σ²_{S})−(½*K*(K+1)*σ²_{B})+(L*K*ρ*σ_{S}*σ_{B})
wherein an instantaneous value Z of the synthetic asset is substantially in accordance with the formula Z=S^{L}/B^{K}, wherein neither L nor K is 0 and wherein the absolute value of either L or K differs from 1.

91. A computer readable medium having computer instructions provided thereon for enabling a computer system to perform a method of managing an investment account, the method comprising:
allocating an amount of cash in an investment account for purchasing one or more positions in one or more underlying assets and/or derivatives thereof;
purchasing at least one such position for the account with the allocated cash; and
targeting a value Z of each position substantially in accordance with the formula Z=A*S^{L}, wherein S is substantially equal to the value of the corresponding underlying asset, L is a substantially constant leverage value of the corresponding position and wherein A is a number of units of the corresponding position.

92. The computer readable medium according to claim 91, wherein targeting comprises:
determining a first delta value corresponding to the targeted value Z for a position in the account,
determining a second current delta value of the holdings for the position, and
comparing the second delta value with the first delta value, and wherein
upon the second delta value being outside a predetermined range of the first delta value, the method further comprises purchasing positions in the underlying asset and/or derivatives thereof to produce a third delta value of the position, wherein the third delta value is within the predetermined range.

93. A computer application program operational on a computer for performing a method of managing an investment account, the method comprising:
allocating an amount of cash in an investment account for purchasing one or more positions in one or more underlying assets and/or derivatives thereof,
purchasing at least one such position for the account with the allocated cash; and
targeting a value Z of each position of the account substantially in accordance with the formula Z=A*S^{L}, wherein S is substantially equal to the value of the corresponding underlying asset and L is a substantially constant leverage value of the corresponding position and A is a number of synthetic units of the corresponding position.

94. The computer application program according to claim 93, wherein targeting comprises:
determining a first delta value corresponding to the targeted value Z for a position in the account,
determining a second current delta value of the holdings for the position, and
comparing the second delta value with the first delta value, and wherein
upon the second delta value being outside a predetermined range of the first delta value, the method further comprises purchasing positions in the underlying asset and/or derivatives thereof to produce a third delta value of the position, wherein the third delta value is within the predetermined range.

95. A system for managing an investment account comprising:
a computer system in communication with a computer network for presenting and/or interacting with an investment account; and
input means for allocating an amount of cash of the investment account for purchasing a position in one or more underlying assets or derivatives thereof and/or for selecting a leveraging value and for purchasing at least one position for the account in at least one asset with the allocated cash, wherein a value Z of each position of the account is targeted substantially in accordance with the formula Z=A*S^{L}, wherein each value of S is substantially equal to the value of the corresponding underlying asset and L is a substantially constant leverage value for the corresponding position and A is a number of units of the corresponding position.

96. A computer readable medium having computer instructions provided thereon for enabling a computer to perform a method of managing an investment account, the method comprising:
allocating an amount of cash in an investment account for purchasing one or more position in one or more underlying target or benchmark assets and/or derivatives thereof,
purchasing at least one such position for the account with the allocated cash; and
targeting a value Z of each position of the account substantially in accordance with the formula Z=A*S^{L}/B^{K}, wherein S is substantially equal to the value of the corresponding target asset, L is a substantially constant leverage value of the corresponding target asset, A is a number of units of the corresponding position and wherein B is the value of a corresponding benchmark asset and K is a substantially constant negative leveraging factor for the corresponding benchmark asset.

97. The computer readable medium according to claim 96, wherein targeting comprises:
determining a first delta value corresponding to a targeted value Z for a position in the account;
determining a second delta value of the holdings for the position, and
comparing the second delta value with the first delta value, wherein upon the second delta value being outside a predetermined range of the first delta value, the method further comprises purchasing positions in the corresponding target or benchmark assets and/or derivatives thereof to produce a third delta value of the position, and wherein the third delta value is within the predetermined range.

98. A computer application program operational on a computer system for performing a method of managing an investment account, the method comprising:
allocating an amount of cash in an investment account for purchasing one or more positions in one or more underlying target or benchmark assets;
purchasing at least one such position for the account with the allocated cash; and
targeting a value Z of each position of the account substantially in accordance with the formula Z=A*S^{L}/B^{K} wherein each value of S is substantially equal to the value of the corresponding target asset, L is a substantially constant leverage value associated with the corresponding target asset, A is a number of units of the corresponding position and wherein B is
the value of a corresponding underlying benchmark asset and K is a substantially constant negative leveraging factor for the corresponding benchmark asset.

99. The computer application program according to claim 98, wherein targeting comprises:
determining a first delta value corresponding to a targeted value Z for the position;
determining a second delta value of the holdings for the position, and
comparing the second delta value with the first delta value, wherein upon the second delta value being outside a predetermined range of the first delta value, the method further comprises purchasing positions in the corresponding target or benchmark asset and/or derivatives thereof to produce a third delta value of the position, and wherein the third delta value is within the predetermined range.

100. A system for performing a method of managing an investment account comprising:
a computer system in communication with a computer network for presenting and/or interacting with an investment account for purchasing one or more positions in one or more underlying target or benchmark assets or derivatives thereof; and
input means for allocating an amount of cash for purchasing such a position and/or for selecting leverage factors and for purchasing at least one such position for the account with the allocated cash, wherein a value Z of each position of the account is targeted substantially in accordance with the formula Z=A*S^{L}/B^{K}, wherein S is substantially equal to the value of a corresponding target asset, L is a substantially constant leverage value of the corresponding target asset, A is a number of units of the corresponding position, B is the value of the corresponding underlying benchmark asset, and
K is a substantially constant negative leverage value associated with the corresponding benchmark asset.

101. The system according to claim 100, wherein targeting comprises:
determining a first delta value corresponding to a targeted value Z for the position and determining a second delta value of the holdings in the position,
comparing the second delta value with the first delta value, wherein upon the second delta value being outside a predetermined range of the first delta value, and
purchasing positions in the corresponding underlying target or benchmark asset and/or derivatives thereof to produce a third delta value of the position, and wherein the third delta value is within the predetermined range.

102. A method of delta-hedging a synthetic asset substantially in accordance with the formula δ=L*(Z/S), wherein the synthetic asset comprises a first underlying asset having a value S, wherein an instantaneous value Z of the synthetic asset is substantially in accordance with the formula Z=S^{L}, where L is neither 0 nor 1 and L is substantially constant over a period of time.

103. A method of delta-hedging a synthetic asset substantially in accordance with the formula δ=L*(Z/S), wherein the synthetic asset comprises at least one underlying asset having a value S and at least one financial derivatives thereof, wherein an instantaneous value Z of the synthetic asset is substantially in accordance with the formula Z=S^{L}, where L is neither 0 nor 1 and L is substantially constant over a period of time.
